(19) United States
(12) Patent Application Publication
(10) Pub. No.: US 2009/0146954 A1
(43) Pub. Date: Jun. 11, 2009

(54) Wireless Mouse with Companion Wireless Mouse Pad

(76) Inventors: Paul Regen, Felton, CA (US); Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/187,885

(22) Filed: Aug. 7, 2008

Related U.S. Application Data
(60) Provisional application No. 60/992,821, filed on Dec. 6, 2007.

(51) Int. Cl. G06F 3/033; G06F 3/039

(52) U.S. Cl. 345/163

(57) ABSTRACT

A mouse pointer device has an outer shell having a shape to accommodate a user's hand, an inner body enclosing electronic components for the mouse, and having a scrolling wheel implemented at a forward portion of the inner body, and a linear translation interface implemented between the inner body and the outer shell enabling the inner body to be positioned at any point along the translation interface within the outer shell, such that the position of the scrolling wheel is changed relative to the position of the user's hand holding the outer shell. In one embodiment a mouse pad is also provided having a substantially flat surface for engaging a portion of a mouse pointer device and a charging station comprising a pair of upward-extending electrodes for engaging electrodes of a mouse pointer device for charging a power supply in the mouse device.

### CROSS-REFERENCE TO RELATED APPLICATIONS

The present case claims priority to provisional patent application 60/992,281, filed on Dec. 6, 2007, and that application is incorporated herein in its entirety at least by reference.

### BACKGROUND OF THE INVENTION

1. Field of the Invention

The embodiments of the current invention generally relates to computer peripheral devices and particularly to input devices like pointing devices. This invention particularly relates to mouses and mouse pads.

2. Description of Related Art

An input device in the computing industry is generally a computer hardware device used to provide data and control signals to an information processing device. Typical examples of input devices include keyboards and mouses. The pointing devices are the input devices that are used to specify a position in space. A mouse is a very common pointing device. The mouse is a small handheld device which is moved over a horizontal surface to generate data to a computer to move a cursor in the display screen in the computer. The mouse detects a two dimensional movement with respect to the supporting surface. Generally a mouse includes a small case provided with one or more buttons. In some cases, a mouse is also provided with a wheel to enable the user to carry out the various system-dependent operations. The mouses are classified into mechanical mouse and optical mouse.

The first mouse used in 1970 used two gear wheels that are arranged perpendicular to each other. The rotation of each wheel is transformed into a motion along one axis. The ball mouse developed in 1972 has two rollers rolling against the two sides of a single ball that is provided to replace the external wheels. The ball may rotate in any direction. The two rollers are rotated to interrupt optical beams to generate electrical signals that are used to move a pointer in a display screen in the computer. The modern computer mechanical mouse comprises a hard rubber mouse ball and three buttons. Another type of mechanical mouse called analogue mouse uses potentiometers rather than encoder wheels to generate electrical signals. An opto-mechanical mouse is provided with a ball or crossed wheels to detect the rotation of the shaft using an optical encoder with lower friction and improved performance.

An optical mouse is provided with a light-emitting diode and photodiodes to detect the movement of the mouse with respect to the underlying surface. The early optical mouse is developed in two different types. One type of optical mouse is formed with an infrared LED and a four quadrant infrared sensor while the second type of optical sensor is formed with a chip including a light image sensor and a motion detection sensor. A modern surface independent optical mouse is provided with an optoelectronic sensor to collect successive pictures of the surface and an image processing chip. The optical mouse illuminates the surface underneath with a LED or a laser diode. The changes between the successive image frames are detected using an image processing chip. The detected changes in the frames are translated into a movement along the two axes to move a cursor on the display screen.

In recent years, the mouse has become an integral tool for most computer programs as well as for working professionals on computers. Unfortunately, as computer users have become more dependent on mouse input devices, the number of repetitive strain injuries related to the mouse is on the increase. Most of the injuries can be tracked to both faulty movements and awkward postures made during the use of mouse. The use of pointing devices may also lead to musculoskeletal discomfort and injury as a consequence of prolonged exposure to postures involving wrist extension and ulnar deviation. Hence there is a need to improve the design of mouse to provide improved comfort to the users of mouse.

Generally a mouse is powered by connecting it to the computer. A wireless mouse is generally provided with a battery which must be recharged or replaced frequently to provide continuous operations. Hence there is a need to develop a system to charge the wireless mouse when not in use.

### BRIEF SUMMARY OF THE INVENTION

The inventors in the present case have noticed for some time that commercially-available mouse pointing devices are not comfortable for all potential purchasers or users. Some persons have larger hands than others, and some would prefer that the surface upon which the device works might be inclined one way or another. Accordingly the inventors have provided a mouse pointing device having an outer shell having a shape to accommodate a user's hand, an inner body enclosing electronic components for the mouse, and having a scrolling wheel implemented at a forward portion of the inner body, and a linear translation interface implemented between the inner body and the outer shell enabling the inner body to be positioned at any point along the translation interface within the outer shell, such that the position of the scrolling wheel is changed relative to the position of the user's hand holding the outer shell.

In one embodiment device has a planar foot joined to the inner body by an elongated, narrow extension, and the outer shell comprises a linear slot of a width to grip the narrow extension such that the inner body may be moved in the outer shell, and the two remain in relative position when released. The foot may comprise an optical interface for monitoring movement of the mouse over a surface proximate the planar foot.

Also in one embodiment the inner body comprises at least two click buttons in a forward position proximate the scrolling wheel, and the outer shell comprises two cantilever elements positioned to be above the click buttons over the full range of movement of the inner body relative to the outer shell, such that the click buttons may always be operated by movement of the cantilever elements. The cantilever elements may be joined to the rest of the outer shell each by a living hinge.

In some cases the mouse is a wireless mouse, transmitting position information to a host wirelessly. Also in some cases there is a pair of downward-facing electrodes implemented in the inner body in a position and in a manner that the electrodes cannot interfere with movement of the device over a surface for monitoring position information to be transmitted to a host, the electrodes are for engaging a charging interface.

In another aspect the inventors provide a mouse pointer device comprising a forward portion having a scrolling wheel and click buttons implemented on each side of the scrolling wheel, a rearward portion shaped to accommodate a user's cupped palm in use, and a translation interface between the forward and the rearward portions allowing the portions to be moved relatively for increased separation or for closer proximity, to provide comfortable operation for users having hands of significantly different size.

In one embodiment elements for gauging relative movement of the mouse, monitoring operation of the clicker buttons, and transmitting data relative to the movements and operation to a host are all implemented in the forward portion. In some embodiments the mouse is an optical mouse having an optical interface for monitoring movement of the mouse on a surface, and the mouse may be a wireless mouse, transmitting position information to a host wirelessly.

In another aspect of the invention a mouse pad is provided, comprising a substantially flat surface for engaging a portion of a mouse pointer device, and a charging station comprising a pair of upward-extending electrodes for engaging electrodes of a mouse pointer device for charging a power supply in the mouse device. The mouse pad may also have a an extensible USB cable having a male USB connector for engaging a USB port of a host, and two or more female USB ports, the mouse pad serving as a USB hub.

In another embodiment there may be an upper portion and a separate lower tilt pad having a planar upper surface tilted at an angle with a planar lower surface, the lower tilt pad rotatable so the angle of the substantially flat surface for engaging a portion of a mouse pointer device may be angled in a variety of ways relative to a support surface upon which the mouse pad is supported. The upper surface of the lower tilt pad and a bottom surface of the upper portion may have an engagement interface whereby the upper portion and lower tilt pad may be connected. The engagement interface may comprise a set of openings in one of the upper portion and the lower tilt pad, and a matching set of snap-in extensions in the other of the upper portion and the lower tilt pad.

### BRIEF DESCRIPTION OF THE SEVERAL VIEWS OF THE DRAWINGS

FIG. 1 illustrates a side view of a wireless mouse in which the main body is arranged at a rear position inside an outer shell according to an embodiment of the present invention.

FIG. 2 illustrates a side view of the wireless mouse of FIG. 1 in which the main body is arranged at a middle position inside the outer shell according to an embodiment of the present invention.

FIG. 3 illustrates a side view of the wireless mouse of FIG. 1 in which the main body is arranged at a front position inside an outer shell according to an embodiment of the present invention.

FIG. 4 illustrates a rear view of the wireless mouse of FIG. 1 according to an embodiment of the present invention.

FIG. 5 illustrates a bottom view of the wireless mouse of FIG. 1 according to an embodiment of the present invention.

FIG. 6 illustrates a top side perspective view of the wireless mouse of FIG. 1 according to an embodiment of the present invention.

FIG. 7 illustrates a top view of a wireless mouse pad with a charging port according to an embodiment of the present invention.

FIG. 8 illustrates a top perspective view of the wireless mouse pad of FIG. 7 with a wireless mouse according to an embodiment of the present invention.

FIG. 9 illustrates a backside view of the wireless mouse pad of FIG. 7 according to an embodiment of the present invention.

FIG. 10 illustrates an exploded backside view of the wireless mouse pad of FIG. 7 according to an embodiment of the present invention.

### DETAILED DESCRIPTION OF THE INVENTION

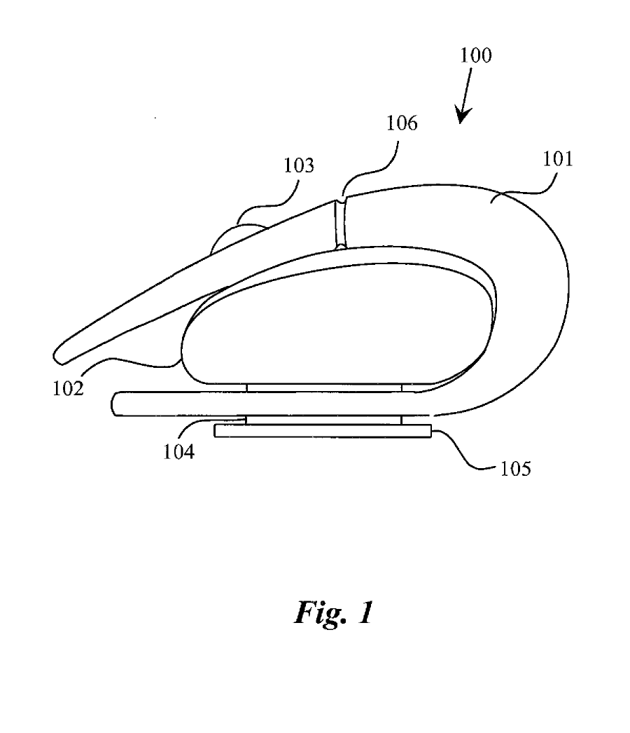

FIG. 1 illustrates a side view of a wireless mouse in which a main body 102 is arranged at a rear position inside an outer shell 101 according to an embodiment of the present invention. With respect to FIG. 1, wireless mouse 100 comprises an outer shell 101 having a left click button with a live hinge mechanism and a right click button also with a live hinge mechanism. Inner housing 102 is slidably arranged within outer shell 101 so as to accommodate the electronic circuit components required for the functioning of wireless mouse 100. Inner housing 102 may be moved and positioned inside outer shell 101 at any desired position, so that inner housing 102 may be positioned to provide a most-comfortable operation for the user. The inner housing may be moved forward and backward in a range of about 2 cm.

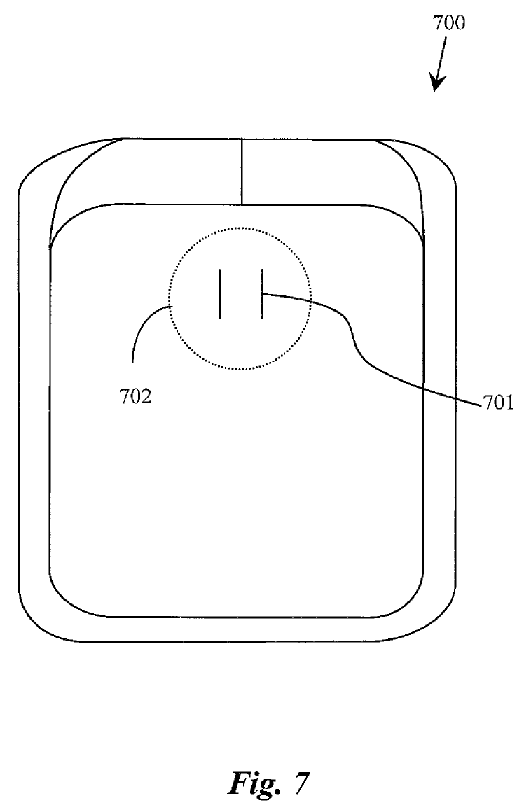

Scroll wheel 103 is provided at a forward position in inner housing 102 so that the scroll wheel is also moved along with inner housing 102. Foot pad 105, which is an integral part of inner body 102, is provided at the bottom, outside the outer shell 101 so that foot pad 105 acts as a slide mechanism to move wireless mouse 100 on any underlying surface. An optical sensor is provided in foot pad 105 to detect the movement of mouse 100 over wireless mouse pad 700 (as shown in FIG. 7). Foot pad 105 is connected to inner housing 102 through an elongated extension 104. Outer shell 101 is provided with a slot to accommodate extension 104 between inner housing 102 and foot pad 105. In one embodiment the width of the slot in outer shell 101 is slightly less than the width of extension 104 so that the slot bears against extension 104.

Live hinge mechanism 106 is provided in both the left and the right sections of outer shell 101 so that a left click button operator and a right click button operator are provided in the top, forward section of outer shell 101. The left and the right click button operators are pressed downwardly by pressing down the front end sections using the fingers to contact buttons (not shown) provided respectively on inner housing 102 to execute the operations of the left and right click buttons. The length of the click button operators allows the click operations to be performed regardless of the position of the inner body with respect to the outer shell. Live hinge mechanism 106 is formed by linking the front end section of outer shell 101 with the rest of the portion of outer shell 101 through a flexible thin plastic region 106 so that the front end sections of outer shell 101 may be moved upwardly or downwardly with respect to the remaining portions of outer shell 101.

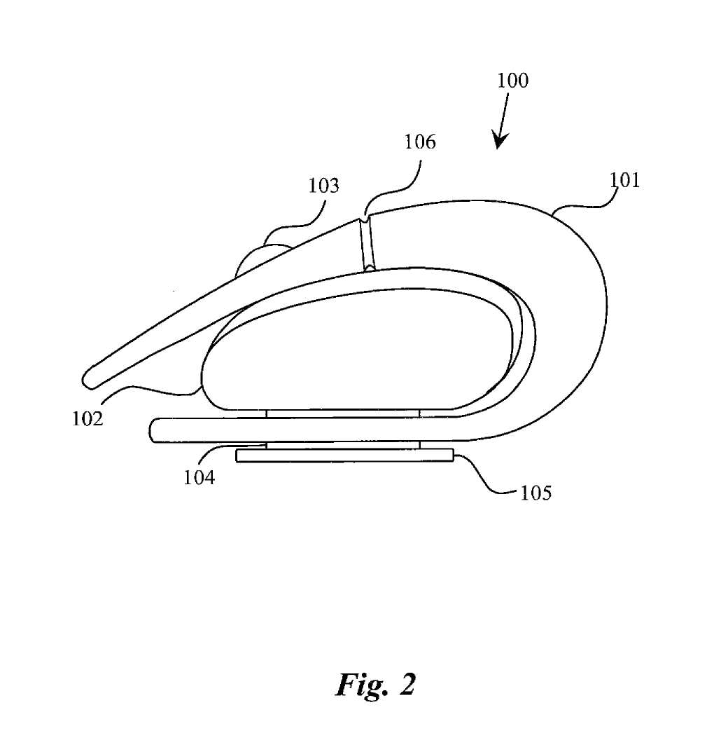

FIG. 2 shows a side view of a wireless mouse in which the main body is arranged at a middle position inside an outer shell according to an embodiment of the present invention.

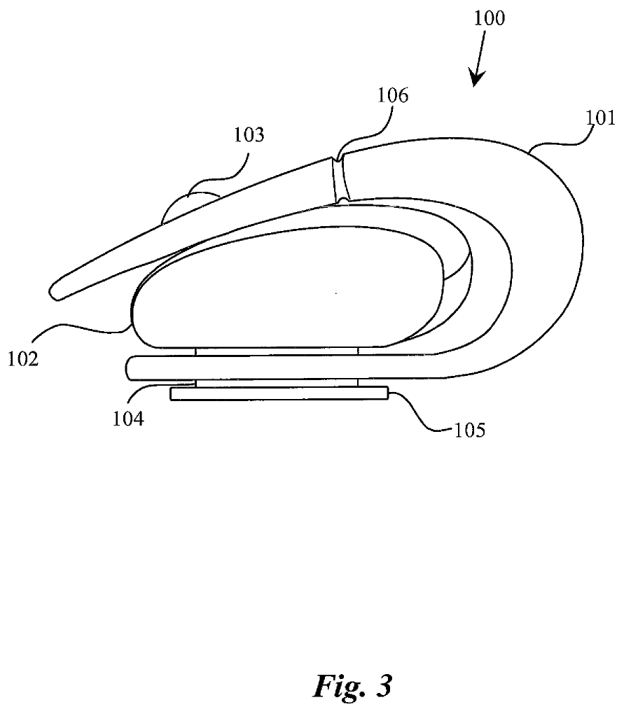

FIG. 3 shows a side view of a wireless mouse in which the main body is arranged at a front position inside an outer shell according to an embodiment of the present invention. FIGS. 1, 2 and 3 are to illustrate that the inner body may be moved to any position in a limited range with respect to the outer shell to accommodate different size hands and preferences of a user.

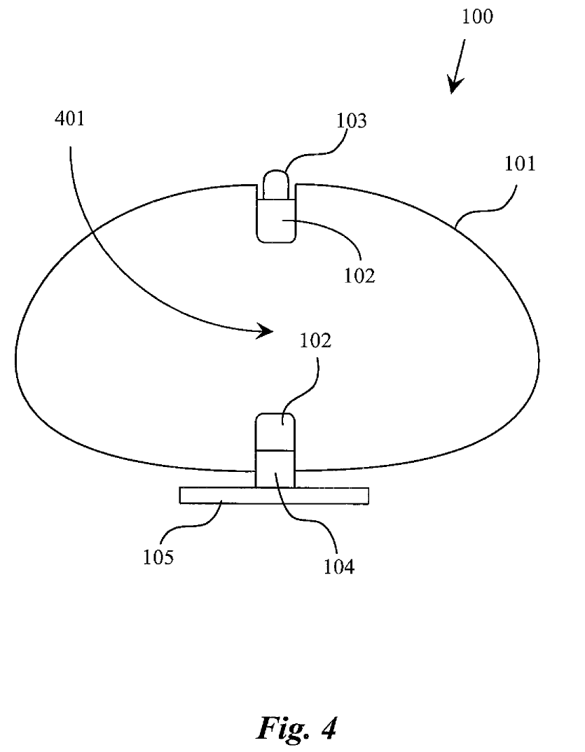

FIG. 4 shows a top view of a wireless mouse according to an embodiment of the present invention. Foot 105 and extension 104 are shown in FIG. 4 as well, and the outer shell in this example is shown as connected by a bridge region 401. In other embodiments the portions of outer shell 101 may be connected or bridged in a different manner.

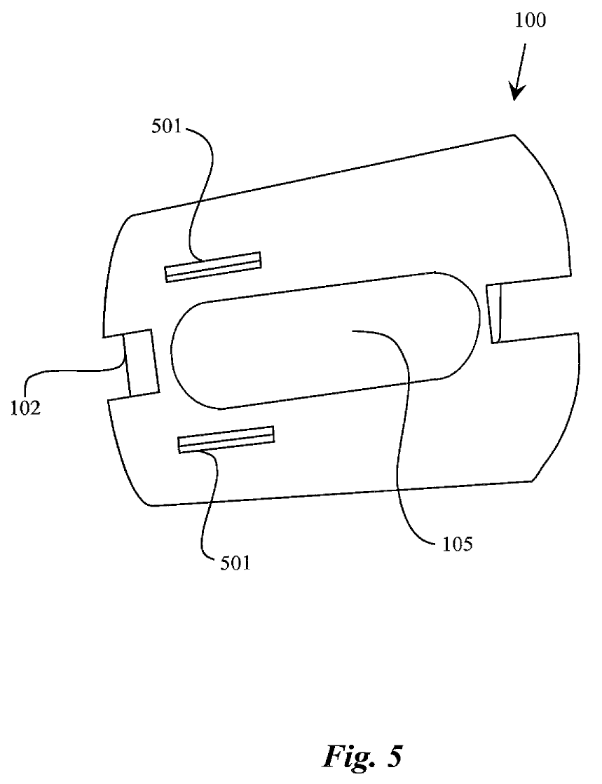

FIG. 5 shows a bottom side view of wireless mouse 100 according to an embodiment of the present invention. Wireless mouse 100 has an outer shell provided with two slots 501 to receive charging pins provided in the wireless mouse pad so that the wireless mouse 100 may be charged with the wireless mouse pad, when wireless mouse 100 is positioned on the charging station in the wireless mouse pad. The pins from the pad extend through slots 501 to make contact with electrodes (not shown) in the inner body of the wireless mouse.

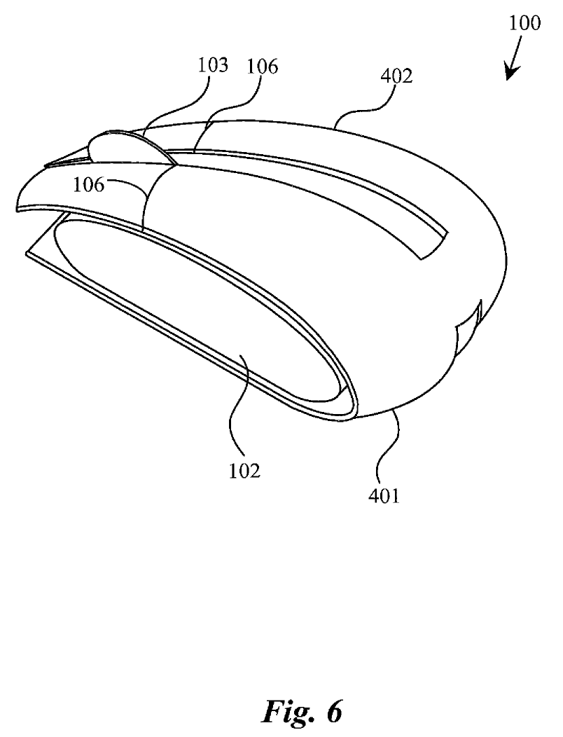

FIG. 6 illustrates a top side perspective view of the wireless mouse of FIGS. 1, 2 and 3 according to an embodiment of the present invention. FIG. 6 is included to provide a better understanding and feel for the features of the wireless mouse of the invention.

FIG. 7 illustrates a top view of a wireless mouse pad with a charging port according to an embodiment of the present invention. With respect to FIG. 7, wireless mouse pad 700 is provided with a charging station 702 at the top surface to charge a wireless mouse, when the wireless mouse is positioned on wireless mouse pad 700. The charging station has two charging elements 701 comprising pins or blades. The charging pins or blades are received in the charging slots provided through the outer shell at the bottom surface of the wireless mouse, and extend through to ports (not shown) in the inner body to charge wireless mouse 100 (as shown in FIG. 1). In an alternative embodiment the ports for receiving the charging pins or blades from the charging station are implemented in foot 105 which is a part of the inner body of the wireless mouse, and in this case the slots through the outer shell are not necessary. Wireless mouse 100 (as shown FIG. 1) may be docked on the charging station in wireless mouse pad 700, when wireless mouse 100 (as shown in FIG. 1) is not used so that wireless mouse 100 (as shown in FIG. 1) may be charged effectively and efficiently.

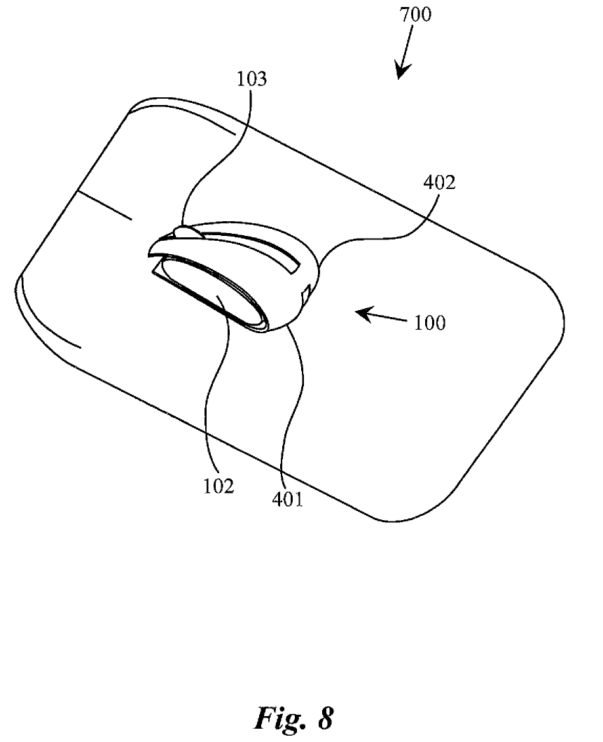

FIG. 8 illustrates a top view of a wireless mouse pad with a wireless mouse according to an embodiment of the present invention. The purpose of FIG. 8 is simply to provide perspective for the reader.

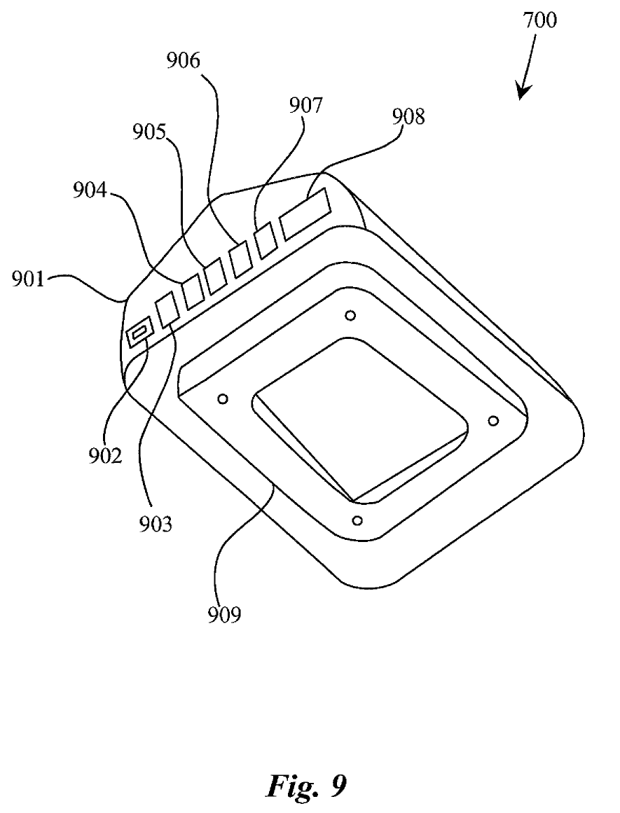

FIG. 9 illustrates a backside view of the wireless mouse pad of FIG. 7 according to an embodiment of the present invention. With respect to FIG. 9, a docking station 901 is provided at the back side of wireless mouse pad 700 to connect, in this example, several peripheral devices to wireless mouse pad 700. Docking station 901 is provided with slots for a retractable USB cord 902, USB ports 903-907 and a flash memory card slot reader 908. USB cord 902, to connect the wireless mouse pad to a USB port of a host computer, and USB female ports 903-907 are provided to connect any other USB-compatible devices as a user might desire, and also in some embodiments to charge the mouse pad. The mouse pad of the invention thus doubles as a USB expansion hub. An ergonomic tilt plate 909 is attached to the bottom surface of mouse pad 700 through a snap fit arrangement in one embodiment to enable the user to achieve a required or desired downward slope for the wireless mouse.

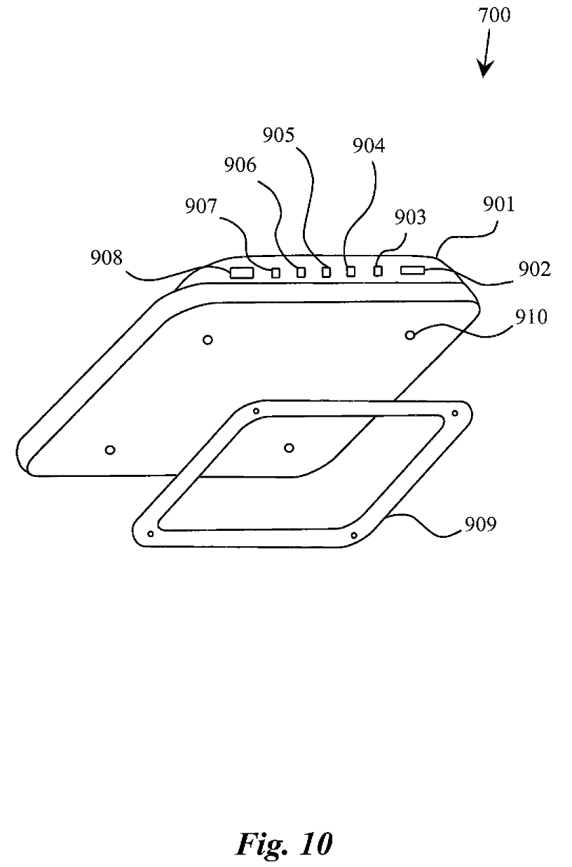

FIG. 10 illustrates an exploded backside view of the wireless mouse pad according to an embodiment of the present invention. With respect to FIG. 10, the USB cord 902, USB ports 903-907 and flash memory card slot reader 908 described with respect to FIG. 9 are shown again. Ergonomic tilt plate 909 is removably attached to the bottom surface of mouse pad 700 through snap fit arrangement to enable the user to achieve a required or desired downward slope for the wireless mouse. Ports 910 in this example receive pins provided in ergonomic tilt plate 909. Tilt plate 909 has an upper plane surface inclined with respect to a lower plane surface, such that a user may tilt the mouse pad in four different directions by disconnecting the tilt plate, rotating in 90 degree increments with respect to the pad, and reattaching it.

In an alternative embodiment a pointer mouse is provided having a forward portion having a scrolling wheel and click buttons implemented on each side of the scrolling wheel, a rearward portion shaped to accommodate a user's cupped palm in use, and a translation interface between the forward and the rearward portions allowing the portions to be moved relatively for increased separation or for closer proximity, to provide comfortable operation for users having hands of significantly different size.

The translation interface may consist of one or more extensions anchored in one of the two potions and engaging openings in the other of a size that the openings grip the extensions, such that the portions may be moved closer together or further apart by force, but remain in relative position when the force is removed. That is, by gripping the two elements one may push or pull to accomplish adjustment, and the engagement friction is enough to keep the final position once attained.

There are a number of ways such a translation interface may be accomplished. In a preferred embodiment all of the electronics and input elements are implemented in the forward portion, so there need not be any electrical or electronic connection between the two portions.

It will be apparent to the skilled artisan that there are a variety of ways the features and functions described above may be implemented without departing from the spirit and scope of the invention. Accordingly the scope of the invention is limited only by the claims that follow.

1. A mouse pointer device, comprising:
an outer shell having a shape to accommodate a user's hand;
an inner body enclosing electronic components for the mouse, and having a scrolling wheel implemented at a forward portion of the inner body; and
a linear translation interface implemented between the inner body and the outer shell enabling the inner body to be positioned at any point along the translation interface within the outer shell, such that the position of the scrolling wheel is changed relative to the position of the user's hand holding the outer shell.

2. The device of claim 1 comprising a planar foot joined to the inner body by an elongated, narrow extension, and the outer shell comprises a linear slot of a width to grip the narrow extension such that the inner body may be moved in the outer shell, and the two remain in relative position when released.

3. The device of claim 2 wherein the foot comprises an optical interface for monitoring movement of the mouse over a surface proximate the planar foot.

4. The device of claim 1 wherein the inner body comprises at least two click buttons in a forward position proximate the scrolling wheel, and the outer shell comprises two cantilever elements positioned to be above the click buttons over the full range of movement of the inner body relative to the outer shell, such that the click buttons may always be operated by movement of the cantilever elements.

5. The device of claim 4 wherein the cantilever elements are joined to the rest of the outer shell each by a live hinge.

6. The device of claim 1 wherein the mouse is a wireless mouse, transmitting position information to a host wirelessly.

7. The device of claim 1 comprising a pair of downward-facing electrodes implemented in the inner body in a position and in a manner that the electrodes cannot interfere with movement of the device over a surface for monitoring position information to be transmitted to a host, the electrodes for engaging a charging interface.

8. A mouse pointer device comprising:
a forward portion having a scrolling wheel and click buttons implemented on each side of the scrolling wheel;
a rearward portion shaped to accommodate a user's cupped palm in use; and
a translation interface between the forward and the rearward portions allowing the portions to be moved relatively for increased separation or for closer proximity, to provide comfortable operation for users having hands of significantly different size.

9. The device of claim 8 wherein elements for gauging relative movement of the mouse, monitoring operation of the clicker buttons, and transmitting data relative to the movements and operation to a host are all implemented in the forward portion.

10. The device of claim 8 wherein the mouse is an optical mouse having an optical interface for monitoring movement of the mouse on a surface.

11. The device of claim 8 wherein the mouse is a wireless mouse, transmitting position information to a host wirelessly.

12. A mouse pad comprising:
a substantially flat surface for engaging a portion of a mouse pointer device; and
a charging station comprising a pair of upward-extending electrodes for engaging electrodes of a mouse pointer device for charging a power supply in the mouse device.

13. The mouse pad of claim 12 further comprising an extensible USB cable having a male USB connector for engaging a USB port of a host, and two or more female USB ports, the mouse pad serving as a USB hub.

14. The mouse pad of claim 12 comprising an upper portion and a separate lower tilt pad having a planar upper surface tilted at an angle with a planar lower surface, the lower tilt pad rotatable so the angle of the substantially flat surface for engaging a portion of a mouse pointer device may be angles in a variety of ways relative to a support surface upon which the mouse pad is supported.

15. The mouse pad of claim 14 wherein the upper surface of the lower tilt pad and a bottom surface of the upper portion have an engagement interface whereby the upper portion and lower tilt pad may be connected.

16. The mouse pad of claim 15 wherein the engagement interface comprises a set of openings in one of the upper portion and the lower tilt pad, and a matching set of snap-in extensions in the other of the upper portion and the lower tilt pad.
